(19) United States
(12) Patent Application Publication
(10) Pub. No.: US 2020/0007599 A1
(43) Pub. Date: Jan. 2, 2020

(54) COLLABORATION SERVER AND METHOD

(71) Applicant: iZettle Merchant Services AB, Stockholm (SE)

(72) Inventor: Alexander Gernandt SEGERBY, Stockholm (SE)

(21) Appl. No.: 16/426,118

(22) Filed: May 30, 2019

(30) Foreign Application Priority Data
Jun. 1, 2018 (SE) 1850669-1

(51) Int. Cl. H04L 29/06

(52) U.S. Cl. CPC H04L 65/4015

(57) ABSTRACT

A collaboration method and server for controlling fulfilment of one or more criteria defined by two or more collaborating parties, the method including receiving a first collaboration data input by a first party; determining, at the collaboration server, whether the received first collaboration data corresponds to a predefined format; transmitting a second signal indicative of the first collaboration data to a second party; and receiving, at the collaoration server from the second electronic device, a confirmation of the first collaboration data, wherein the confirmation is input by the second party via the second user interface of the second electronic device, and wherein the confirmation is indicative of that the first collaboration data is agreed upon between the first party and the second party.

### TECHNICAL FIELD

The disclosure pertains to the field of servers and methods for controlling fulfilment of one or more criteria defined by collaborating parties.

### BACKGROUND

Today when parties are engaged in business and/or collaboration with each other, the relation between the parties is often regulated by one or plural agreements between the different parties. Traditionally, the parties of a business relation define the content of the agreements together and agrees upon the conditions in a written text that is defining the agreement. It is common that the parties meet in person and verify who they are e.g. by identification documents that verify e.g. legal persons and companies. The parties sign a printed hardcopy of the agreement, and it is common that a certain number of hard copies are signed to be kept by the parties of the agreement. The agreement may define e.g. quantified numbers, e.g. a sum of money or a sales figure, a sales volume, a turnover, etc. The agreement may also define e.g. certain countries, business partners, third parties, goals, etc. In order to verify that a party of the agreement is meeting the criteria defined by collaborating parties, one party may e.g. request another party to verify a certain profit, a certain sales volume, etc. The number may be verified by e.g. a sales order from a client, a tax decision by the authorities, a receipt, etc. A breach of the agreement may be determined in a similar way. Sometimes an agreement needs to be renegotiated if any of the parties would like to make amendments to the agreement. It is then common that the parties of the agreement meet again, face to face, and a new drafted agreement is agreed upon and hard copies are signed by the parties to verify the agreement between the parties.

### SUMMARY

Today there is a demand for a more efficient and secure way to manage agreements between business and collaboration parties. In particular, there is a demand for a more smooth, secure, reliable and effective way to follow up on agreements in order to control fulfilment of one or more criteria defined by collaborating parties. There is also a demand for minimizing the management of renegotiating of agreements and minimizing the need for face-to-face meetings between the different parties.

An object of the present disclosure is to provide devices and methods which seek to mitigate, alleviate, or eliminate one or more of the above-identified deficiencies in the art and disadvantages singly or in any combination.

The disclosure proposes a collaboration method of a collaboration server for controlling fulfilment of one or more criteria defined by two or more collaborating parties. The method comprising the step of receiving, at a collaboration server, a first signal from a first electronic device, wherein the first signal is indicative of first collaboration data input by a first party via a first user interface of a first electronic device. The method is then followed by the step of determining, at the collaboration server, whether the received first collaboration data corresponds to a predefined format by comparing the received first collaboration data with the predefined format. Responsive to determining that the received first collaboration data corresponds to the predefined format, the method is then followed by the step of transmitting, from the collaboration server to a second electronic device, a second signal wherein the second signal is indicative of the first collaboration data, wherein the transmitting is for provision of the first collaboration data to a second party via a second user interface of a second electronic device. Responsive to transmitting, the method is then followed by the step of receiving, at the collaboration server from the second electronic device, a third signal wherein the third signal is indicative of a confirmation of the first collaboration data, wherein the confirmation is input by the second party via the second user interface of the second electronic device, and wherein the confirmation is indicative of that the first collaboration data is agreed upon between the first party and the second party. An advantage with the method is that at least two parties can agree upon collaboration data without being present at the same geographical location.

According to an aspect the method further comprises the step of receiving, at the collaboration server from the first electronic device, a fourth signal wherein the fourth signal is indicative of a first collaboration fulfilment data input by the first party via the first user interface of the first electronic device, wherein the first collaboration fulfilment data is associated with the first collaboration data. The method is then followed by the step of determining at the collaboration server whether the one or more criteria is fulfilled by comparing the received first collaboration fulfilment data with the first collaboration data. In other words, an advantage with the method is that the collaboration server can determine if of one or more criteria is fulfilled without involvement of any of the other parties.

According to an aspect the method further comprising the step of transmitting, from the collaboration server to a first entity server associated with a service provider, in response to a receiving the fourth signal indicative of the first collaboration fulfilment data or in response to a fulfilment request, a fifth signal wherein the fifth signal is indicative of a request for a second collaboration fulfilment data, wherein the second collaboration fulfilment data is associated with the first collaboration data. The method is then followed by the step of receiving, at the collaboration server from the first entity server, a sixth signal wherein the sixth signal is a response signal indicative of the second collaboration fulfilment data and the method is then followed by the step of determining at the collaboration server whether the one or more criteria is fulfilled by comparing the received second collaboration fulfilment data with the first collaboration data. This means that the first collaboration data, or the received first collaboration fulfilment data, can be verified by another entity in a reliable and effective way without involvement of any of the other parties.

According to an aspect the method further comprising the step of transmitting, from the collaboration server to the second electronic device, a seventh signal wherein the seventh signal is indicative of at least one of the first and second collaboration fulfilment data, wherein the transmitting is for provision of at least one of the first and second collaboration fulfilment data to the second party via the second user interface of the second electronic device and the method further comprising the step of, responsive to transmitting, receiving, at the collaboration server from the second electronic device, an eighth signal wherein the eighth signal is indicative of a confirmation of at least one of the first or second collaboration fulfilment data, wherein the confirmation is input by the second party via the second user interface of the second electronic device, for confirming that the first or second collaboration fulfilment data is approved by the second party. An advantage is that the second party can, from a distance via the second electronic user device, approve the first or second collaboration fulfilment data at any time of the day and independent on the geographical location of the second party.

According to an aspect the method further comprising the step of receiving, at the collaboration server, an identification signal from at least the first electronic device, wherein the identification signal is indicative of identification data input by at least the first party via at least the first user interface of the at least first electronic device. The method is then followed by the step of transmitting, from the collaboration server to a second entity server associated with a service provider, an identity confirmation request signal wherein the identity confirmation request signal comprises the identification data and then the method is followed by the step of receiving, at the collaboration server, from the second entity server, an identity confirmation response signal, wherein the identity confirmation response signal comprises a confirmation of the identification data of at least one collaborating party determined by comparing the identification data with an existing identification data at the second entity server. This means that the identity of any party can be verified which makes the method more reliable but also more effective since the parties does not need to meet.

According to an aspect the step of determining, at the collaboration server, whether the received first collaboration data corresponds to a predefined format comprises determining whether the received first collaboration data corresponds to a value that is within a predefined value interval. This means that the collaboration server can determine if the collaboration data corresponds to a value that is within a predefined value interval without involvement of any other party.

According to an aspect the step of determining, at the collaboration server, whether the received first collaboration data corresponds to a predefined format comprises determining whether the received first collaboration data corresponds to a value that is one of a plurality of predefined values. This means that the collaboration server can determine if the collaboration data corresponds to a value that is one of a plurality of predefined values without involvement of any other party.

According to an aspect the step of transmitting the second signal is initiated responsive to determining that the received first collaboration data corresponds to the predefined format and that the collaboration data corresponds to a suggested change of a previous collaboration data agreed upon between at least the first party and the second party and that the first collaboration data corresponds to a value outside of a predefined value interval or outside of one of a plurality of predefined values. In other words, the collaboration server only involves the second party if needed in order to manage amendments of the agreement as effective as possible.

According to an aspect, comparing the first or second collaboration fulfilment data with the first collaboration data comprises determining if the collaboration fulfilment data corresponds to a value within a predefined value interval or to one of a plurality of predefined values. In other words, the collaboration server can by itself determine if the collaboration fulfilment data corresponds to a value within a predefined value interval or to one of a plurality of predefined values without involvement of any other party.

According to an aspect, the first collaboration fulfilment data is a value obtained from an electronic document input by the first party via a document input interface of the first electronic device and sent from the first electronic device to the collaboration server. This means that the collaboration server can obtain data from an electronic document without involvement of any other party.

According to an aspect, at least one of the first entity server or the second entity server is connected to the collaboration server via a secure application-programming interface. An advantage with this is that the collaboration server has a secure defined connection with any of first entity server or the second entity server.

According to an aspect the collaboration fulfilment data comprises any of a sales data, a product data, a financial transaction data, a numerical data, a geographical position data, a country data, a tax figure data, a name data or a card number data. In other words, the collaboration fulfilment data can be any of a plurality of data types.

According to an aspect, the electronic document comprises any of a loan contract, a certificate, a permit, an invoice, a sales order or a board decision. In other words, the electronic document can be any of a plurality of document types.

The disclosure further proposes a collaboration server for controlling fulfilment of one or more criteria defined by two or more collaborating parties. The collaboration server comprising a processing circuitry. The processing circuitry is configured to cause the collaboration server to receive, at the collaboration server, a first signal from a first electronic device, wherein the first signal is indicative of first collaboration data input by a first party via a first user interface of a first electronic device. The processing circuitry is further configured to cause the collaboration server to determine, at the collaboration server, whether the received first collaboration data corresponds to a predefined format by comparing the received first collaboration data with the predefined format. The processing circuitry is further configured to cause the collaboration server to, responsive to determining that the received first collaboration data corresponds to the predefined format, transmit, from the collaboration server to a second electronic device, a second signal wherein the second signal is indicative of the first collaboration data, wherein the transmitting is for provision of the first collaboration data to a second party via a second user interface of a second electronic device. The processing circuitry is further configured to cause the collaboration server to, responsive to transmit, receive, at the collaboration server from the second electronic device, a third signal wherein the third signal is indicative of a confirmation of the first collaboration data, wherein the confirmation is input by the second party via the second user interface of the second electronic device, and wherein the confirmation is indicative of that the first collaboration data is agreed upon between the first party and the second party. An advantage with the method is that at least two parties can agree upon collaboration data without being present at the same geographical location.

According to an aspect the processing circuitry is further configured to cause the collaboration server to receive, at the collaboration server from the first electronic device, a fourth signal wherein the fourth signal is indicative of a first collaboration fulfilment data input by the first party via the first user interface of the first electronic device, wherein the first collaboration fulfilment data is associated with the first collaboration data. The processing circuitry is further configured to cause the collaboration server to determine at the collaboration server whether the one or more criteria is fulfilled by comparing the received first collaboration fulfilment data with the first collaboration data. In other words, an advantage with the method is that the collaboration server can determine if of one or more criteria is fulfilled without involvement of any of the other parties.

According to an aspect the processing circuitry is further configured to cause the collaboration server to transmit in response to receiving the fourth signal indicative of the first collaboration fulfilment data or in response to a fulfilment request, from the collaboration server to a first entity server associated with a service provider, a fifth signal wherein the fifth signal is indicative of a request for a second collaboration fulfilment data, wherein the second collaboration fulfilment data is associated with the first collaboration data. The processing circuitry is further configured to cause the collaboration server to receive, at the collaboration server from the first entity server, a sixth signal wherein the sixth signal is a response signal indicative of the second collaboration fulfilment data and determine at the collaboration server whether the one or more criteria is fulfilled by comparing the received second collaboration fulfilment data with the first collaboration data. This means that fulfilment of collaboration data or verification of received collaboration fulfilment data can be verified by another entity in a reliable and effective way without involvement of any of the other parties.

According to an aspect the processing circuitry is further configured to cause the collaboration server to transmit, from the collaboration server to the second electronic device, a seventh signal wherein the seventh signal is indicative of at least one of the first and second collaboration fulfilment data, wherein the transmitting is for provision of at least one of the first and second collaboration fulfilment data to the second party via the second user interface of the second electronic device. The processing circuitry is further configured to cause the collaboration server to, responsive to transmit, receive, at the collaboration server from the second electronic device, an eighth signal wherein the eighth signal is indicative of a confirmation of at least one of the first or second collaboration fulfilment data, wherein the confirmation is input by the second party via the second user interface of the second electronic device, for confirming that the first or second collaboration fulfilment data is approved by the second party. An advantage is that the second party can, from a distance via the second electronic user device, approve the first or second collaboration fulfilment data at any time of the day and independent on the geographical location of the second party.

According to an aspect, at least one of the first entity or the second entity is connected to the collaboration server via a secure application-programming interface. An advantage with this is that the collaboration server has a secure defined connection with any of first entity server or the second entity server.

According to an aspect, the electronic document comprising any of a loan contract, a certificate, a permit, an invoice, a sales order or a board decision. In other words, the electronic document can be any of a plurality of document types.

The disclosure further proposes a computer program product comprising a non-transitory computer readable medium, having thereon a computer program comprising program instructions, the computer program being loadable into a processing circuitry and configured to cause execution of the described method when the computer program is run by the processing circuitry. This means that the method can be run on a plurality of collaboration servers.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates an example collaboration server according to some aspects connected to first and second electronic devices and to first and second entity servers.

FIG. 2 illustrates example signalling between a collaboration server and first and second electronic devices and first and second entity servers according to some aspects.

FIG. 3a illustrates a flow chart of example method steps according to some aspects.

FIG. 3b-3c illustrates a flow chart of example method steps according to some aspects.

FIG. 4 illustrates an example computer program being loadable into a processing circuitry according to an aspect of the disclosure.

### DETAILED DESCRIPTION

Aspects of the present disclosure will be described more fully hereinafter with reference to the accompanying drawings. The method and device disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

Today there is a demand for a more efficient and secure way to manage agreements between business and collaboration parties. In particular, there is a demand for a more smooth, secure, reliable and effective way to follow up on agreements in order to control fulfilment of one or more criteria defined by collaborating parties. There is also a demand for minimizing the management of renegotiating of agreements and minimizing the need for face-to-face meetings between the different parties.

An object of the present disclosure is to provide devices and method which seek to mitigate, alleviate, or eliminate one or more of the above-identified deficiencies in the art and disadvantages singly or in any combination.

The inventor proposes a collaboration server, a collaboration method and a computer program product that will be described in more detail supported by the figures.

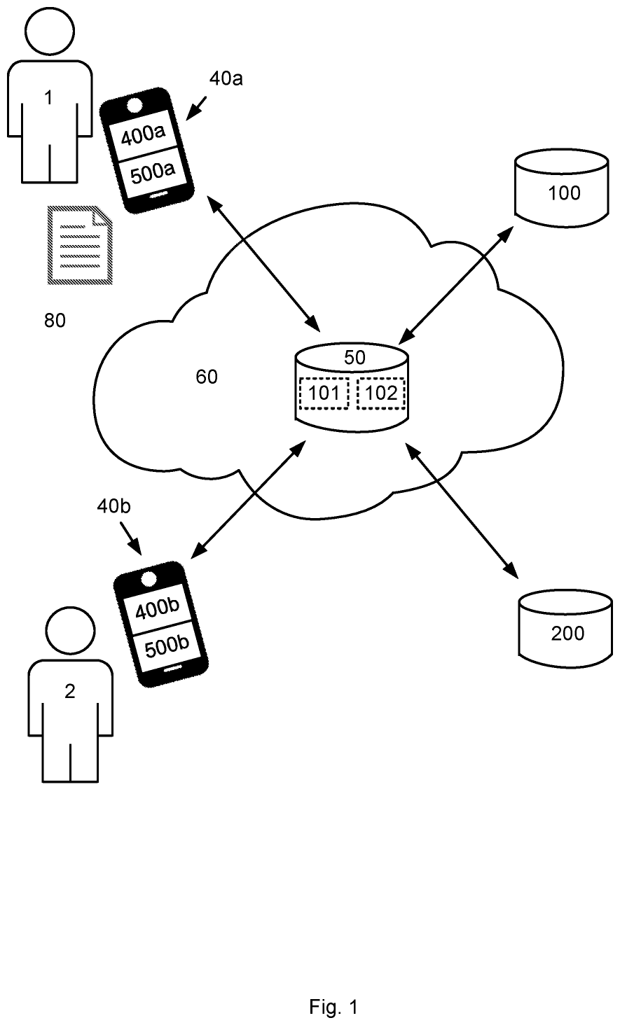

FIG. 1 illustrates the collaboration server 50 by example. According to some aspects, the collaboration server 50 comprises a memory 101 configured to store information. According to an aspect the collaboration server 50 comprising a processing circuitry 102 configured to process information. The collaboration server 50 is configured to be connected to a first electronic device 40a and/or a second electronic device 40b. According to an aspect, the electronic device 40a, 40b is a stationary electronic device such as a computer. According to an aspect, the electronic device 40a, 40b is a portable electronic device. In one example, the electronic device 40a, 40b is any of a smartphone, a tablet or a laptop computer.

As illustrated in FIG. 1, the first electronic device 40a is operated by a first party 1 and the second electronic device 40b is operated by a second party 2. In one example, the party 1,2 is a human that is representing any of a natural person, a legal person, a company, a corporation, an authority, an organization etc. According to an aspect, there may be at least two parties 1,2 that are collaborating in any kind of engagement such as a business relation. According to an aspect the collaborating parties 1,2 are engaged in a business and/or collaboration with each other and the relation between the parties needs to be regulated by one or plural of agreements between the collaborating parties.

According to an aspect the electronic device 40a, 40b further comprising a user interface 400a, 400b. The party 1,2 is operating the electronic device 40a, 40b via the user interface 400a, 400b. According to an aspect, the user interface 400a, 400b is configured for output of information to the party 1,2 via a display and/or a speaker of the electronic device 40a, 40b.

According to an aspect the user interface 400a, 400b is further configured for input of information from the party 1, 2. According to an aspect the user interface 400a, 400b is any of a touch sensitive display, display combined with a keyboard or a voice controlled user interface.

According to an aspect the electronic device 40a, 40b further comprising a document input interface 500a, 500b. In an example, the document input interface 500a, 500b is a camera or document scanner configured to convert physical document into an electronic copy of the physical document. According to an aspect the document input interface 500a, 500b is configured to generate an electronic copy of a physical document 80 using optical character recognition technology. In an example, the physical document is a paper with text and figures that is scanned by the document input interface 500a, 500b and converted into an electronic copy of the physical document using optical character recognition technology.

The collaboration server 50 is further configured to be connected to a first entity server 100 and/or a second entity server 200.

The collaboration server 50 is configured to be connected to the electronic devices 40a, 40b and the entity servers 100, 200 via a communication network 60. According to an aspect, the collaboration server 50 is configured to be wirelessly connected to the electronic devices 40a, 40b and the entity servers 100, 200 via the communication network 60.

In one example the communication network 60 is a standardized wireless wide area network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-Internet of Things, NB-IoT, Fifth Generation, 5G, Worldwide Interoperability for Microwave Access, WiMAX or Ultra Mobile Broadband, UMB or similar network.

In one example the communication network 60 is a standardized wireless local area network such as a Wireless Local Area Network, WLAN, Bluetooth™, ZigBee, Ultra-Wideband, Near Field Communication, NFC, Radio Frequency Identification, RFID, or similar network.

The communication network 60 can also be a combination of both a local area network and a wide area network. The communication network 60 can also be wired networks. According to an aspect of the disclosure, the communication network 50 is defined by common Internet Protocols. In other words, the electronic device 40a, 40b can be connected to the collaboration server 50 independent on the geographical location.

The disclosure proposes a collaboration method of a collaboration server 50 for controlling fulfilment of one or more criteria defined by two or more collaborating parties. According to an aspect the criteria is defined by fulfilment of a collaboration data that is a quantitative data that can be compared with other quantitative data. In one example, the collaboration data is a defined monetary value, such as an annual turnover, or a sales value during a certain period. In one example, the collaboration data is a number value, such as the number of soled products, or number of countries, or number of employees etc. The collaboration data can also be defined names of e.g. products or countries.

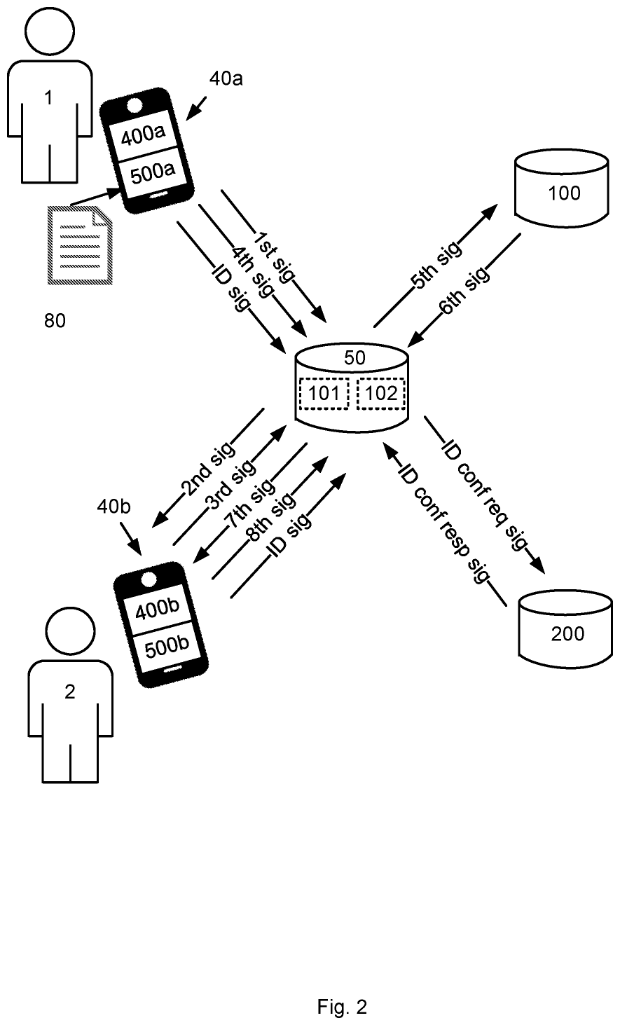

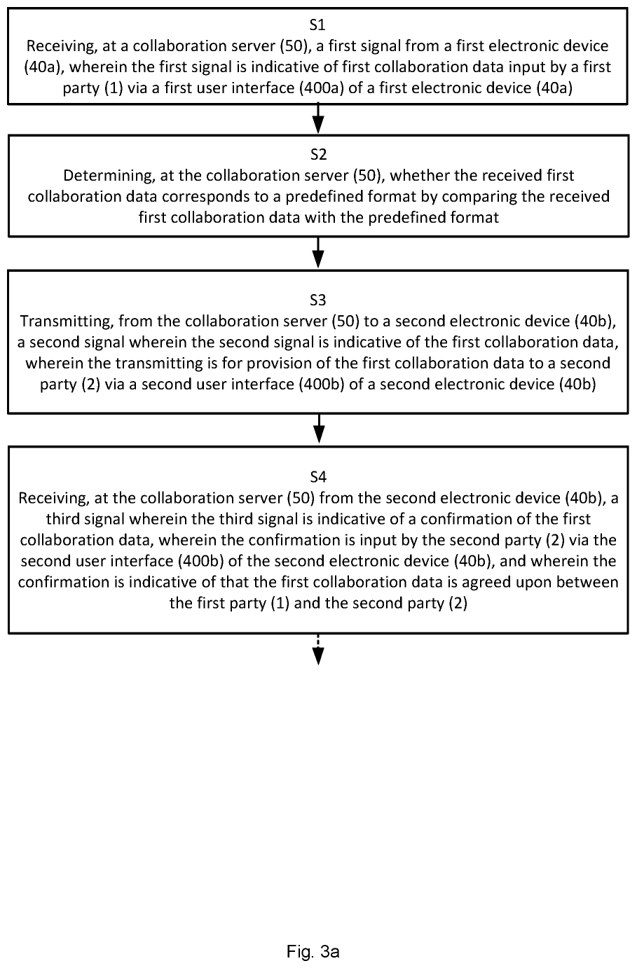

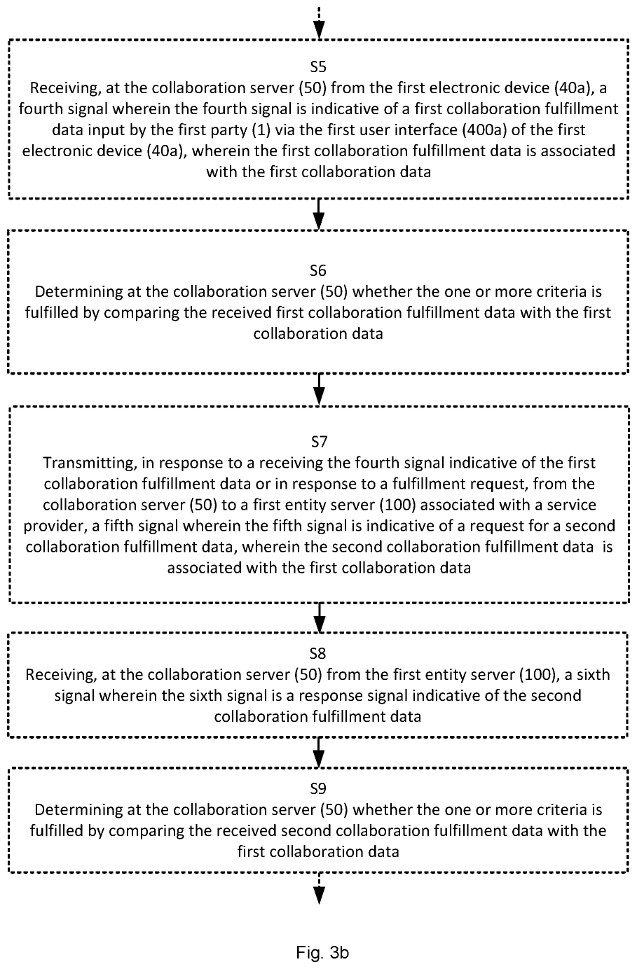

FIG. 3a illustrates a flow chart of the proposed method steps of the disclosure. FIG. 2 illustrates the signalling between the collaboration server 50 and the first and second electronic devices 40a, 40b and the first and second entity servers 100, 200.

As illustrated in FIG. 3a, the method comprising the step of S1 receiving, at a collaboration server 50, a first signal from a first electronic device 40a, wherein the first signal is indicative of first collaboration data input by a first party 1 via a first user interface 400a of a first electronic device 40a. The signals are illustrated in FIG. 2 corresponding method steps.

According to an aspect, the first collaboration data is input by the first party 1 when establishing the relation with the second party 2 via the collaboration server 50. In one example, the first collaboration data has been discussed with the at least second party 2 as criteria for entering into business with the first party 1. In an example, the first collaboration data is in a context together with a definition of the first collaboration data such as a number that is the number of sold products during a certain period of time.

The method is then followed by the step of S2 determining, at the collaboration server 50, whether the received first collaboration data corresponds to a predefined format by comparing the received first collaboration data with the predefined format.

According to an aspect the step of S2 determining, at the collaboration server 50, whether the received first collaboration data corresponds to a predefined format, comprises determining whether the received first collaboration data corresponds to a value that is within a predefined value interval. This means that the collaboration server 50 can determine if the collaboration data corresponds to a value that is within a predefined value interval without involvement of any other party.

According to an aspect the step of S2 determining, at the collaboration server 50, whether the received first collaboration data corresponds to a predefined format comprises determining whether the received first collaboration data corresponds to a value that is one of a plurality of predefined values. This means that the collaboration server 50 can determine if the collaboration data corresponds to a value that is one of a plurality of predefined values without involvement of any other party.

According to an aspect, the predefined format is defined by at least the second party 2 before the first party 1 input the first collaboration data. In one example, the predefined format defines that the collaboration data must be a numerical value, an alphabetic value, a country, a currency or a certain unit etc. The predefined format can also in one example relate to e.g. a value in an interval of plural values, or to a country out of a selection of plural predefined countries etc. Hence, in one example, the predefined format is a numerical value, and in one example, the predefined format is an alphanumerical vale. According to an aspect, the collaboration data is only accepted if the collaboration data corresponds to a predefined format in form of a value that is within a value interval. In one example it is determined that the collaboration data is in a format that is within boundaries of initial conditions that has been set by at least the second party 2 such as a monetary amount that is within a predefined interval of monetary amounts.

According to an aspect the first collaboration, data does not correspond to a predefined format wherein the first party 1 is notified accordingly via the user interface 400a of the first user device 40a. In an example, the first party 1 is prompted to enter a value that corresponds to a predefined format.

Responsive to determining that the received first collaboration data corresponds to the predefined format, the method is then followed by the step of S3 transmitting, from the collaboration server 50 to a second electronic device 40b, a second signal wherein the second signal is indicative of the first collaboration data, wherein the transmitting is for provision of the first collaboration data to a second party 2 via a second user interface 400b of a second electronic device 40b. The second signal is illustrated in FIG. 2. In one example the second party 2 is notified that the first party 1 has input the first collaboration data and the second party 2 is prompted via the second user interface 400b of the second electronic device 40b to take action on the first collaboration data, e.g. approve or deny the first collaboration data input by the first party 1. According to an aspect the second signal, indicative of the first collaboration data, is trigged by that the first collaboration data does not correspond to a predefined format.

Responsive to transmitting, the method is then followed by the step of S4 receiving, at the collaboration server 50 from the second electronic device 40b, a third signal wherein the third signal is indicative of a confirmation of the first collaboration data, wherein the confirmation is input by the second party 2 via the second user interface 400b of the second electronic device 40b, and wherein the confirmation is indicative of that the first collaboration data is agreed upon between the first party 1 and the second party 2. The third signal is illustrated in FIG. 2. An advantage with the method is that at least two parties can agree upon collaboration data without being present at the same geographical location. In other words, the first party 1 and the second party 2 can agree upon the first collaboration data from different geographical locations via the electronic devices 40a, 40b that are connected via the collaboration server 50. According to an aspect the third signal is indicative of a rejection of the first collaboration data, wherein the rejection is input by the second party 2 via the second user interface 400b of the second electronic device 40b, and wherein the rejection is indicative of that the first collaboration data is not agreed upon between the first party 1 and the second party 2. In other words, the first and second parties 1,2 do not agree and needs to start over.

As illustrated in FIG. 3a and FIG. 3b, according to an aspect the method step S4 can be followed by the method step S5. Hence, according to an aspect, as illustrated in FIG. 3b, the method further comprising the step of S5 receiving, at the collaboration server 50 from the first electronic device 40a, a fourth signal wherein the fourth signal is indicative of a first collaboration fulfilment data input by the first party 1 via the first user interface 400a of the first electronic device 40a, wherein the first collaboration fulfilment data is associated with the first collaboration data. The fourth signal is illustrated in FIG. 2. According to an aspect, the collaboration fulfilment data is data that is entered by the first party 1 to follow up on the collaboration data agreed upon between the first party 1 and the second party 2.

According to an aspect, the first collaboration fulfilment data is the actual data of a previous estimated first collaboration fulfilment data. In an example, the first collaboration fulfilment data is the actual turnover value a certain year input by the first party 1 and the first collaboration data the forecast of the turnover value for that year input by the first party 1. In one example the first collaboration fulfilment data comprising the name of two countries where a certain product has been sold and the first collaboration data comprising the names of named countries where a certain product is agreed to be been sold.

According to an aspect, as illustrated in FIG. 3b, the method is then followed by the step of S6 determining at the collaboration server 50 whether the one or more criteria is fulfilled by comparing the received first collaboration fulfilment data with the first collaboration data. In other words, an advantage with the method is that the collaboration server 50 can determine if of one or more criteria is fulfilled without involvement of any of the other parties. This means that the collaboration server 50 can continuously keep track is one or more criteria is fulfilled or not.

According to an aspect the method further comprising the step of S7 transmitting, from the collaboration server 50 to a first entity server 100 associated with a service provider, in response to a receiving the fourth signal indicative of the first collaboration fulfilment data or in response to a fulfilment request, a fifth signal wherein the fifth signal is indicative of a request for a second collaboration fulfilment data, wherein the second collaboration fulfilment data is associated with the first collaboration data. The fifth signal is illustrated in FIG. 2. According to an aspect, the fulfilment request is a request generated by the collaboration server 50. According to an aspect, the fulfilment request is a request generated by an input by the second party 2 via the user interface 400b of the second electronic device 40b. According to an aspect, the fulfilment request is continuously generated by the collaboration server 50. According to an aspect, the collaboration server 50 is connected to the first entity server 100 and configured to transmit the fifth signal, indicative of a request for a second collaboration fulfilment data, according to a predefined schedule. In one example, the first entity server 100 is associated with a service provider such as a tax authority, a company registration authority, a credit institute, a bank, a financial service provider.

According to an aspect, as illustrated in FIG. 3b, the method is then followed by the step of S8 receiving, at the collaboration server 50 from the first entity server 100, a sixth signal wherein the sixth signal is a response signal indicative of the second collaboration fulfilment data and the method is then followed by the step of S9 determining at the collaboration server 50 whether the one or more criteria is fulfilled by comparing the received second collaboration fulfilment data with the first collaboration data. The sixth signal is illustrated in FIG. 2. This means that the first collaboration data, or the received first collaboration fulfilment data, can be verified by another entity in a reliable and effective way without involvement of any of the other parties. In one example, any party can generate the fulfilment request at any time in order to verify the first collaboration data. In an example the first collaboration fulfilment data is the actual turnover value a certain year input by the first party 1 and the first collaboration data the forecast of the turnover value for that year input by the first party 1 and the second collaboration fulfilment data is the actual turnover value a certain year retrieved from the first entity server 100. In one example, the second collaboration fulfilment data is an objective confirmation that is more reliable than the first collaboration fulfilment data input by the first party 1.

As illustrated in FIG. 3b and FIG. 3c, according to an aspect the method step S9 can be followed by the method step S10. Hence, according to an aspect, as illustrated in FIG. 3c, the method further comprising the step of S10 transmitting, from the collaboration server 50 to the second electronic device 40b, a seventh signal wherein the seventh signal is indicative of at least one of the first and second collaboration fulfilment data, wherein the transmitting is for provision of at least one of the first and second collaboration fulfilment data to the second party 2 via the second user interface 400b of the second electronic device 40b. The seventh signal is illustrated in FIG. 2. In other words, the second party 2 can be notified of the first or second collaboration fulfilment data via the second user interface 400b of the second electronic device 40b. In one example, the second electronic device 40b is configured to generate e.g. a sound, visual or tactile notification so that the second party 2 can take action on the received notification in an effective way. The method further comprising the step of 511 responsive to transmitting, S4 receiving, at the collaboration server 50 from the second electronic device 40b, an eighth signal wherein the eighth signal is indicative of a confirmation of at least one of the first or second collaboration fulfilment data, wherein the confirmation is input by the second party 2 via the second user interface 400b of the second electronic device 40b, for confirming that the first or second collaboration fulfilment data is approved by the second party 2. The seventh signal is illustrated in FIG. 2. An advantage is that the second party can, from a distance via the second user interface 400b of the second electronic device 40b, approve the first or second collaboration fulfilment data at any time of the day and independent on the geographical location of the second party. In other words, the second party 2 can in a reliable and comfortable way control fulfilment of one or more criteria defined by two or more collaborating parties. In this way, the collaborating parties can build trust in their collaboration and/or business relation in an effective and smooth way.

According to an aspect the method further comprising the step of receiving, at the collaboration server 50, an identification signal from at least the first electronic device 40a, 40b, wherein the identification signal is indicative of identification data input by at least the first party 1,2,n via at least the first user interface 400a, 400b of the at least first electronic device 40a,40b. The identification signal ID sig is illustrated in FIG. 2. In one example, the identification data input is a social security number, a company registration number, a birth data number, a tax registration number, an organization number etc. The method is then followed by the step of transmitting, from the collaboration server 50 to a second entity server 200 associated with a service provider, an identity confirmation request signal wherein the identity confirmation request signal comprises the identification data and then the method is followed by the step of receiving, at the collaboration server 50, from the second entity server 200, an identity confirmation response signal, wherein the identity confirmation response signal comprises a confirmation of the identification data of at least one collaborating party determined by comparing the identification data with an existing identification data at the second entity server 200. The identity confirmation request signal ID conf req sig is illustrated in FIG. 2. This means that the identity of any party can be verified which makes the method more reliable but also more effective since the parties does not need to meet. In one example, the second entity server 200 is associated with an authority, a bank, a personal data service provider, a secure identification service provider. According to an aspect the second entity server 200 comprising identification data of a plurality of parties for verifying the identity of the parties. According to an aspect the identity confirmation response signal is received at the collaboration server 50 after entering any of a personal identification number, a code, a fingerprint, face recognition data or any biometrical data by the at least the first party 1,2,n via at least the first user interface 400a, 400b of the at least first electronic device 40a,40b. The identity confirmation response signal ID conf resp sig is illustrated in FIG. 2. According to an aspect the identity confirmation response signal is a secure verified identity of the at least the first party 1,2,n. In other words, the identity of each party can be verified via the collaboration server 50 which adds trust to the collaboration and/or business relation between the different parties.

According to an aspect the step of S3 transmitting the second signal is initiated responsive to determining that the received first collaboration data corresponds to the predefined format and that the collaboration data corresponds to a suggested change of a previous collaboration data agreed upon between at least the first party 1 and the second party 2 and that the first collaboration data corresponds to a value outside of a predefined value interval or outside of one of a plurality of predefined values. In other words, the collaboration server 50 only involves the second party 2 if needed in order to manage amendments of the agreement as effective as possible.

According to an aspect, comparing the first or second collaboration fulfilment data with the first collaboration data comprises determining if the collaboration fulfilment data corresponds to a value within a predefined value interval or to one of a plurality of predefined values. In other words, the collaboration server 50 can by itself determine if the collaboration fulfilment data corresponds to a value within a predefined value interval or to one of a plurality of predefined values without involvement of any other party.

According to an aspect, the first collaboration fulfilment data is a value obtained from an electronic document input by the first party 1 via a document input interface 500a, 500b of the first electronic device 40a and sent from the first electronic device 40a to the collaboration server 50. This means that the collaboration server 50 can obtain data from an electronic document without involvement of any other party.

According to an aspect, at least one of the first entity server 100 or the second entity server 200 is connected to the collaboration server 50 via a secure application-programming interface. An advantage with this is that the collaboration server 50 have a secure defined connection with any of first entity server 100 or the second entity server 200.

According to an aspect the collaboration fulfilment data comprises any of a sales data, a product data, a financial transaction data, a numerical data, a geographical position data, a country data, a tax figure data, a name data or a card number data. In other words, the collaboration fulfilment data can be any of a plurality of data types.

According to an aspect, the electronic document 80 comprises any of a loan contract, a certificate, a permit, an invoice, a sales order or a board decision. In other words, the electronic document can be any of a plurality of document types.

The disclosure further proposes a collaboration server 50 for controlling fulfilment of one or more criteria defined by two or more collaborating parties.

The collaboration server 50 is configured to carry out the described method and any aspects or combination of aspects of the method according to the disclosure.

The collaboration server 50 comprising a processing circuitry 102. The a processing circuitry 102 is configured to cause the collaboration server 50 to receive, at the collaboration server 50, a first signal from a first electronic device 40a, wherein the first signal is indicative of first collaboration data input by a first party 1 via a first user interface 400a of a first electronic device 40a. The processing circuitry 102 is further configured to cause the collaboration server 50 to determine, at the collaboration server 50, whether the received first collaboration data corresponds to a predefined format by comparing the received first collaboration data with the predefined format. The processing circuitry 102 is further configured to cause the collaboration server 50 to, responsive to determining that the received first collaboration data corresponds to the predefined format, transmit, from the collaboration server 50 to a second electronic device 40b, a second signal wherein the second signal is indicative of the first collaboration data, wherein the transmitting is for provision of the first collaboration data to a second party 2 via a second user interface 400b of a second electronic device 40b. The processing circuitry 102 is further configured to cause the collaboration server 50 to, responsive to transmit, receive, at the collaboration server 50 from the second electronic device 40b, a third signal wherein the third signal is indicative of a confirmation of the first collaboration data, wherein the confirmation is input by the second party 2 via the second user interface 400b of the second electronic device 40b, and wherein the confirmation is indicative of that the first collaboration data is agreed upon between the first party 1 and the second party 2. An advantage with the method is that at least two parties can agree upon collaboration data without being present at the same geographical location.

According to an aspect the processing circuitry 102 is further configured to cause the collaboration server 50 to receive, at the collaboration server 50 from the first electronic device 40a, a fourth signal wherein the fourth signal is indicative of a first collaboration fulfilment data input by the first party 1 via the first user interface 400a of the first electronic device 40a, wherein the first collaboration fulfilment data is associated with the first collaboration data. The processing circuitry 102 is further configured to cause the collaboration server 50 to determine at the collaboration server 50 whether the one or more criteria is fulfilled by comparing the received first collaboration fulfilment data with the first collaboration data. In other words, an advantage with the method is that the collaboration server can determine if of one or more criteria is fulfilled without involvement of any of the other parties.

According to an aspect the processing circuitry 102 is further configured to cause the collaboration server 50 to transmit in response to receiving the fourth signal indicative of the first collaboration fulfilment data or in response to a fulfilment request, from the collaboration server 50 to a first entity server 100 associated with a service provider, a fifth signal wherein the fifth signal is indicative of a request for a second collaboration fulfilment data, wherein the second collaboration fulfilment data is associated with the first collaboration data. The processing circuitry 102 is further configured to cause the collaboration server 50 to receive, at the collaboration server 50 from the first entity server 100, a sixth signal wherein the sixth signal is a response signal indicative of the second collaboration fulfilment data and determine at the collaboration server 50 whether the one or more criteria is fulfilled by comparing the received second collaboration fulfilment data with the first collaboration data. This means that fulfilment of collaboration data or verification of received collaboration fulfilment data can be verified by another entity in a reliable and effective way without involvement of any of the other parties.

According to an aspect the processing circuitry 102 is further configured to cause the collaboration server 50 to transmit, from the collaboration server 50 to the second electronic device 40b, a seventh signal wherein the seventh signal is indicative of at least one of the first and second collaboration fulfilment data, wherein the transmitting is for provision of at least one of the first and second collaboration fulfilment data to the second party 2 via the second user interface 400b of the second electronic device 40b. The processing circuitry 102 is further configured to cause the collaboration server 50 to, responsive to transmit, receive, at the collaboration server 50 from the second electronic device 40b, an eighth signal wherein the eighth signal is indicative of a confirmation of at least one of the first or second collaboration fulfilment data, wherein the confirmation is input by the second party 2 via the second user interface 400b of the second electronic device 40b, for confirming that the first or second collaboration fulfilment data is approved by the second party 2. An advantage is that the second party can, from a distance via the second electronic user device, approve the first or second collaboration fulfilment data at any time of the day and independent on the geographical location of the second party.

According to an aspect, at least one of the first entity 100 or the second entity 200 is connected to the collaboration server 50 via a secure application-programming interface. An advantage with this is that the collaboration server 50 have a secure defined connection with any of first entity server 100 or the second entity server 200.

According to an aspect, the electronic document 80 comprising any of a loan contract, a certificate, a permit, an invoice, a sales order or a board decision. In other words, the electronic document can be any of a plurality of document types.

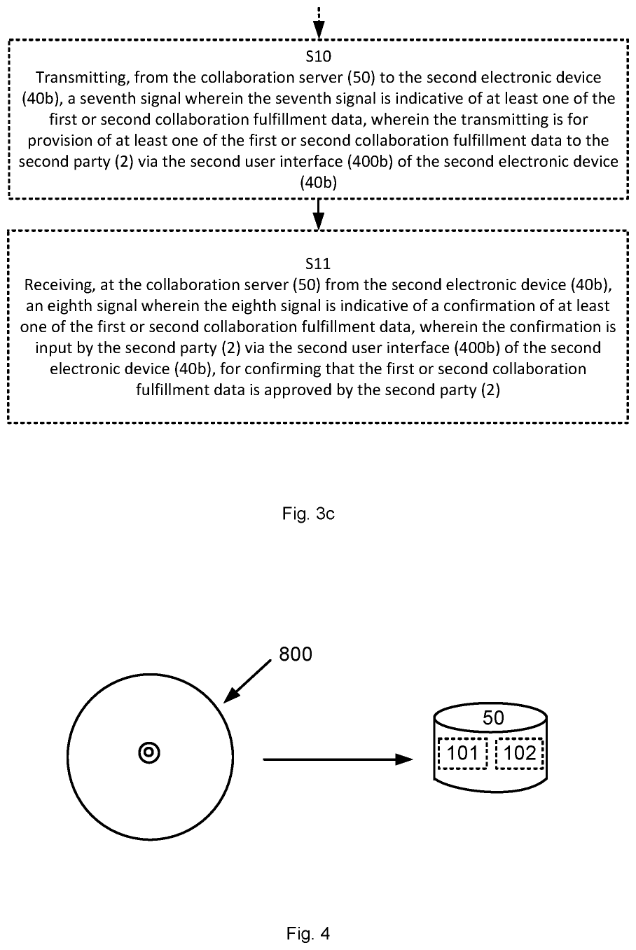

FIG. 4 illustrates an example computer program being loadable into a processing circuitry according to an aspect of the disclosure. The disclosure further proposes a computer program product comprising a non-transitory computer readable medium, having thereon a computer program comprising program instructions, the computer program being loadable into a processing circuitry and configured to cause execution of the described method when the computer program is run by the processing circuitry. This means that the method can be run on a plurality of collaboration servers.

The use of any of the method, the computer program product or the the collaboration server 50 will now be exemplified with a use case. In this use case a first party 1 is about to engage in a business with a second party 2. The first party 1 and the second party 2 have briefly discussed the conditions for a possible business agreement for engaging in business and collaboration with each other. The identity of the first party 1 is verified by a second entity server associated with a personal identity service by the collaboration server 50. The second party 2 expects the first party 1 to have a turnover that is at least between 10-30 M USD the first year. The first party 1 suggests to at least a 12 M USD in turnover by entering via a first user interface 400a of a first electronic device 40a the 12 M USD as the first collaboration data. The collaboration server 50 determines that the 12 M USD corresponds to a predefined format, in this example within the predefined interval at least between 10-30 M USD the first year, and the second party 2 is notified via the second user interface 400b of the second electronic device 40b. The second party 2 approves that the at least 12 M USD is the criteria that need to be fulfilled in order to maintain the business agreement between the first party 1 and the second party 2. After the first year, the first party 1 is prompted to follow up on the turnover. The first party 1 inputs 14 M USD as indicative of a first collaboration fulfillment data. At the collaboration server 50 it is determined that the criteria are fulfilled by comparing the 14 M USD with the agreed at least 12 M USD. In order to have an objective verification of the first collaboration data the collaboration server 50 requests for a second collaboration fulfillment data from a first entity server 100 that is associated with the tax authority. The response signal indicative of the second collaboration fulfillment data discloses a turnover that is 13,96 M USD. At the collaboration server 50 it is determined that the criteria are fulfilled by comparing the 13,96 M USD with the agreed at least 12 M USD. The second party 2 is notified about the 14 M USD and the 13,96 M USD and confirms that the criteria is fulfilled.

The different aspects of the disclosure can be combined with one or more of the other different aspects. In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A collaboration method of a collaboration server for controlling fulfilment of one or more criteria defined by two or more collaborating parties, the method comprising:
receiving, at a collaboration server, a first signal from a first electronic device, wherein the first signal is indicative of first collaboration data input by a first party via a first user interface of a first electronic device;
determining, at the collaboration server, whether the received first collaboration data corresponds to a predefined format by comparing the received first collaboration data with the predefined format;
responsive to determining that the received first collaboration data corresponds to the predefined format, transmitting, from the collaboration server to a second electronic device, a second signal wherein the second signal is indicative of the first collaboration data, wherein the transmitting is for provision of the first collaboration data to a second party via a second user interface of a second electronic device; and
responsive to transmitting, receiving, at the collaboration server from the second electronic device, a third signal wherein the third signal is indicative of a confirmation of the first collaboration data, wherein the confirmation is input by the second party via the second user interface of the second electronic device, and wherein the confirmation is indicative of that the first collaboration data is agreed upon between the first party and the second party.

2. The method according to claim 1 further comprising:
receiving, at the collaboration server from the first electronic device, a fourth signal wherein the fourth signal is indicative of a first collaboration fulfillment data input by the first party via the first user interface of the first electronic device, wherein the first collaboration fulfillment data is associated with the first collaboration data; and
determining at the collaboration server whether the one or more criteria is fulfilled by comparing the received first collaboration fulfillment data with the first collaboration data.

3. The method according to claim 2 further comprising:
transmitting, from the collaboration server to a first entity server associated with a service provider, in response to a receiving the fourth signal indicative of the first collaboration fulfillment data or in response to a fulfillment request, a fifth signal wherein the fifth signal is indicative of a request for a second collaboration fulfillment data, wherein the second collaboration fulfillment data is associated with the first collaboration data;
receiving, at the collaboration server from the first entity server, a sixth signal wherein the sixth signal is a response signal indicative of the second collaboration fulfillment data; and
determining at the collaboration server whether the one or more criteria is fulfilled by comparing the received second collaboration fulfillment data with the first collaboration data.

4. The method according to claim 3 further comprising:
transmitting, from the collaboration server to the second electronic device, a seventh signal wherein the seventh signal is indicative of at least one of the first and second collaboration fulfillment data, and is for provision of at least one of the first and second collaboration fulfillment data to the second party via the second user interface of the second electronic device; and
responsive to transmitting the seventh signal, receiving, at the collaboration server from the second electronic device, an eighth signal wherein the eighth signal is indicative of a confirmation of at least one of the first and second collaboration fulfillment data, wherein the confirmation is input by the second party via the second user interface of the second electronic device, for confirming that the first or second collaboration fulfillment data is approved by the second party.

5. The method according to claim 1, further comprising:
receiving, at the collaboration server, an identification signal from at least the first electronic device, wherein the identification signal is indicative of identification data input by at least the first party via at least the first user interface of the at least first electronic device;
transmitting, from the collaboration server to a second entity server associated with a service provider, an identity confirmation request signal wherein the identity confirmation request signal comprises the identification data; and
receiving, at the collaboration server, from the second entity server, an identity confirmation response signal, wherein the identity confirmation response signal comprises a confirmation of the identification data of at least one collaborating party determined by comparing the identification data with an existing identification data at the second entity server.

6. The method according to claim 1, wherein the determining, at the collaboration server, whether the received first collaboration data corresponds to a predefined format comprises determining whether the received first collaboration data corresponds to a value that is within a predefined value interval.

7. The method according to claim 1, wherein the determining, at the collaboration server, whether the received first collaboration data corresponds to a predefined format comprises determining whether the received first collaboration data corresponds to a value that is one of a plurality of predefined values.

8. The method according to claim 1, wherein transmitting the second signal is initiated responsive to determining that the received first collaboration data corresponds to the predefined format and that the collaboration data corresponds to a suggested change of a previous collaboration data agreed upon between at least the first party and the second party and that the first collaboration data corresponds to a value outside of a predefined value interval or outside of one of a plurality of predefined values.

9. The method according to claim 2, wherein comparing the first or second collaboration fulfillment data with the first collaboration data comprises determining if the collaboration fulfillment data corresponds to a value within a predefined value interval or to one of a plurality of predefined values.

10. The method according to claim 2 wherein the first collaboration fulfillment data is a value obtained from an electronic document input by the first party via a document input interface of the first electronic device and sent from the first electronic device to the collaboration server.

11. The method according to claim 5, wherein at least one of the first entity server and the second entity server is connected to the collaboration server via a secure application-programming interface.

12. The method according to claim 1, wherein the collaboration fulfillment data comprises any of a sales data, a product data, a financial transaction data, a numerical data, a geographical position data, a country data, a tax figure data, a name data or a card number data.

13. The method according to claim 8, wherein the electronic document comprises any of a loan contract, a certificate, a permit, an invoice, a sales order or a board decision.

14. A collaboration server for controlling fulfilment of one or more criteria defined by two or more collaborating parties, the collaboration server comprising:
a processing circuitry configured to cause the collaboration server to:
receive, at the collaboration server, a first signal from a first electronic device, wherein the first signal is indicative of first collaboration data input by a first party via a first user interface of a first electronic device;
determine, at the collaboration server, whether the received first collaboration data corresponds to a predefined format by comparing the received first collaboration data with the predefined format;
responsive to determining that the received first collaboration data corresponds to the predefined format, transmit, from the collaboration server to a second electronic device, a second signal wherein the second signal is indicative of the first collaboration data, wherein the transmitting is for provision of the first collaboration data to a second party via a second user interface of a second electronic device; and
responsive to transmit, receive, at the collaboration server from the second electronic device, a third signal wherein the third signal is indicative of a confirmation of the first collaboration data, wherein the confirmation is input by the second party via the second user interface of the second electronic device, and wherein the confirmation is indicative of that the first collaboration data is agreed upon between the first party and the second party.

15. A collaboration server according to claim 14 wherein the processing circuitry is further configured to cause the collaboration server to:
receive, at the collaboration server from the first electronic device, a fourth signal wherein the fourth signal is indicative of a first collaboration fulfillment data input by the first party via the first user interface of the first electronic device, wherein the first collaboration fulfillment data is associated with the first collaboration data; and
determine at the collaboration server whether the one or more criteria is fulfilled by comparing the received first collaboration fulfillment data with the first collaboration data.

16. A collaboration server according to claim 15 wherein the processing circuitry is further configured to cause the collaboration server to:
transmit in response to receiving the fourth signal indicative of the first collaboration fulfillment data or in response to a fulfillment request, from the collaboration server to a first entity server associated with a service provider, a fifth signal wherein the fifth signal is indicative of a request for a second collaboration fulfillment data, wherein the second collaboration fulfillment data is associated with the first collaboration data;
receive, at the collaboration server from the first entity server, a sixth signal wherein the sixth signal is a response signal indicative of the second collaboration fulfillment data; and
determine at the collaboration server whether the one or more criteria is fulfilled by comparing the received second collaboration fulfillment data with the first collaboration data.

17. A collaboration server according to claim 16 wherein the processing circuitry is further configured to cause the collaboration server (50) to:
transmit, from the collaboration server to the second electronic device, a seventh signal wherein the seventh signal is indicative of at least one of the first and second collaboration fulfillment data, wherein the transmitting is for provision of at least one of the first and second collaboration fulfillment data to the second party via the second user interface of the second electronic device; and
responsive to transmit, receive, at the collaboration server from the second electronic device, an eighth signal wherein the eighth signal is indicative of a confirmation of at least one of the first or second collaboration fulfillment data, wherein the confirmation is input by the second party via the second user interface of the second electronic device, for confirming that the first or second collaboration fulfillment data is approved by the second party.

18. A collaboration server according to claim 14 wherein at least one of the first entity or the second entity (200) is connected to the collaboration server via a secure application programming interface.

19. A collaboration server according to claim 14 wherein the electronic document comprising any of a loan contract, a certificate, a permit, an invoice, a sales order or a board decision.

20. A computer program product comprising a non-transitory computer readable medium, having thereon a computer program comprising program instructions, the computer program being loadable into a processing circuitry and configured to cause execution of the method according to claim 1 when the computer program is run by the processing circuitry.
